(19) United States
(12) Patent Application Publication
(10) Pub. No.: US 2004/0226016 A1
(43) Pub. Date: Nov. 11, 2004

(54) Apparatus and method for sharing resources in a real-time processing system

(75) Inventor: Sreedharan P. Sreejith, Murphy, TX (US)

Correspondence Address: DOCKET CLERK, P.O. DRAWER 800889, DALLAS, TX, 75380, US

(73) Assignee: SAMSUNG ELECTRONICS CO., LTD., Suwon-City (KR)

(21) Appl. No.: 10/431,771

(22) Filed: May 8, 2003

(51) Int. Cl. G06F 9/00

(52) U.S. Cl. 718/104

(57) ABSTRACT

Disclosed herein are apparatus and methods for sharing resources in a real-time processing system. According to an advantageous embodiment, a real-time processing system is introduced that (i) executes application, kernel and interrupt-service processes utilizing processor resources selectively allocated thereto and (ii) handles interrupt-service requests received from interrupt sources associated with the real-time processing system. The real-time processing system comprises a controller that operates to monitor resource-utilization limits associated with each of the interrupt sources.

### TECHNICAL FIELD OF THE INVENTION

The present invention is directed generally to real-time processing systems and, in particular, to a leaky bucket-based fair resource allocation mechanism for use in a real-time processing system.

### BACKGROUND OF THE INVENTION

Real-time processing devices, such as servers, workstations, routers, personal computers, and the like, often execute several concurrent jobs. In a typical real-time processing environment, the data processing module may host numerous kernel processes and application processes having various priorities. In addition to the user application and kernel processes, the data processing module also handles interrupt functions that have different interrupt priorities. In an environment like this, the processing module must provide real-time responses while allocating processor and memory resources in a fair manner among applications.

Using a moderately sophisticated real-time operating system, it is possible to implement well-defined policies to share the processor and memory resources in a fair manner among applications running on the kernel. However, operating conditions are radically different in systems with hardware interrupts and multiple user applications running simultaneously. Hardware interrupts are external triggers whose occurrence and rate may be unpredictable and non-deterministic. Additionally, interrupts generally have a higher priority compared to kernel functions and user application functions. If a data processor spends too much time servicing interrupts, this may choke off access by the kernel functions and user applications to processor, memory and other resources, thereby shutting down other time-critical applications. This situation may be exacerbated when there are a number of hardware interrupt sources with having different priorities.

Therefore, there is a need in the art for improved apparatuses and methods for implementing a fair resource-sharing algorithm in a real-time processing environment. In particular, there is a need in the art for an improved algorithm for sharing resources in a real-time environment that services a large number of hardware and software interrupts.

### SUMMARY OF THE INVENTION

To address the above-discussed deficiencies of the prior art, it is a primary object of the present invention to introduce apparatus and methods for sharing resources in a real-time processing system using resource-utilization limits associated with each one of a plurality of interrupt sources.

An exemplary real-time processing system is introduced that (i) executes application, kernel and interrupt-service processes utilizing processor resources selectively allocated among the same and (ii) handles interrupt-service requests received from interrupt sources associated with the real-time processing system. The processor resources include at least one processor and memory.

According to an advantageous embodiment, the real-time processing system comprises a controller that operates to (i) associate at least one resource-utilization limit with each of the interrupt sources, (ii) monitor the associated resource-utilization limits of the interrupt sources and (iii) in response to such monitoring, allocate selectively the processor resources among ones of the application, kernel and interrupt-service processes.

In a preferred embodiment, the controller includes a leaky bucket-based fair resource allocation mechanism for use in the real-time processing system. The preferred real-time system fairly shares resources in a controlled manner among multiple application, kernel and interrupt-service processes by throttling the interrupt sources using well-defined policies of the leaky bucket-based mechanism. These policies limit resource usage by interrupt sources (and related interrupt service routines).

The leaky bucket-based fair resource allocation mechanism hereinafter described is particularly suitable for environments wherein the real-time system transfers messages and data packets through completion-interrupts from an external hardware module (e.g., medium access control (MAC) layer chip) and a processor hosting user applications to process the packets.

In a related embodiment, the controller of the exemplary real-time process control system is further operable to modify the various resource-utilization limits. In a first instance, the controller is operable to reset the resource-utilization limits; for instance, the controller may reset the resource-utilization limits in response to a timer (e.g., expiration of a time period, T). In a second instance, the controller is operable to modify selectively the resource-utilization limits associated with the interrupt sources as a function of each respective interrupt sources utilization of the processor resources; for instance, the controller may suitably be operable to modify a first resource-utilization limit associated with a first interrupt source as a function of first interrupt source utilization of allocated processor resources.

In this second instance, the controller is operable, in response to monitoring the modified resource-utilization limits, to allocate the processor resources selectively among ones of the application, kernel and interrupt-service processes. In a related embodiment, each interrupt sources has a priority value associated therewith, some interrupt sources naturally having higher priority values relative to other interrupt sources (such valuation may be statically, dynamically, situationally, or otherwise assigned). The controller is operable, in response to such prioritization and resource-utilization limits, to allocate processor resources selectively among ones of the application, kernel and interrupt-service processes.

According to the preferred embodiment implementing the leaky bucket-based mechanism, each resource-utilization limit includes (i) a first parameter representing a maximum number of events that can occur during the time period T, and (ii) a second parameter representing an average number of events serviced per second.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the terms “controller” and “processor” mean any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present invention and its advantages, reference is now made to the following description taken in conjunction with the accompanying drawings, in which like reference numerals represent like parts:

FIG. 1 illustrates an exemplary communication network containing routers in accordance with the principles of the present invention;

FIG. 2 illustrates selected portions of an exemplary server in accordance with the principles of the present invention;

FIG. 3 is an operational flow diagram illustrating the operation of a real-time processing architecture according to the principles of the present invention.

### DETAILED DESCRIPTION OF THE INVENTION

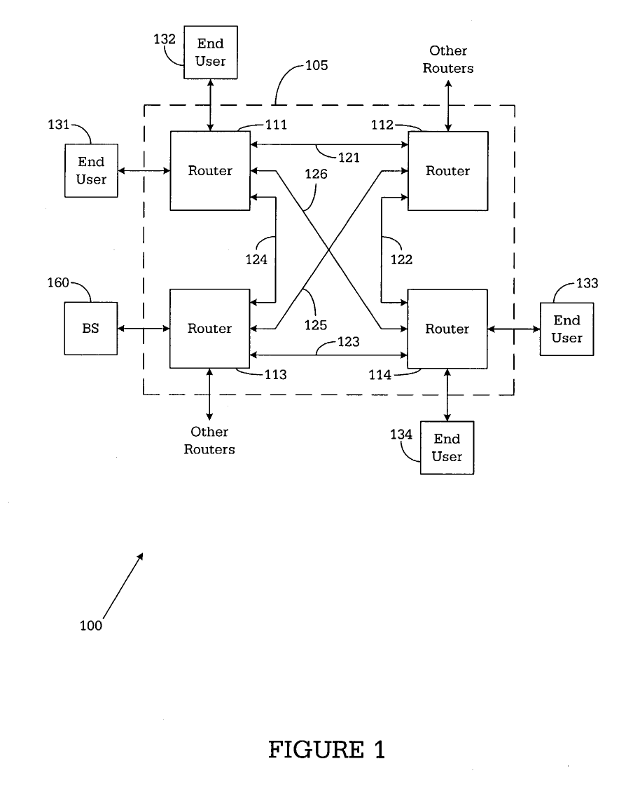

FIGS. 1 through 3, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged real-time processing system.

FIG. 1 provides a first example of a real-time processing device (namely a router) in which resource sharing based on the leaky bucket algorithm may be implemented in accordance with the principles of the present invention. FIG. 1 illustrates exemplary communication network 100 containing routers 111-114 in accordance with the principles of the present invention. Communication network 100 comprises subnetwork 105 (indicated by a dotted line) that contains routers 111-114, that interconnects end-user devices 131-134 with each other and with other routers (not shown) and other end-user devices (not shown) associated with communication network 100. Routers 111-114 are interconnected by data links 121-126. According to an advantageous embodiment of the present invention, one or more of data links 121-126 may comprise multiple data links (i.e., a multilink). For example, data link 121 may comprise two or more of: T1 lines, T3 lines, fiber optic lines, and/or wireless links (i.e., RF channels).

Subnetwork 105 is intended to be a representative portion of communication network 100, which may contain many other routers similar to routers 111-114. Communication network 100 may also comprise wireless equipment, such as a base station, that enables communication network 100 to communicate with wireless devices, such as cellular telephones and/or computers equipped with cellular modems. According to an advantageous embodiment of the present invention, each one of routers 111-114 comprises a data packet switching device that transmits data packets over the data links coupled to each router.

Each one of routers 111-114 provides a real-time processing environment that interfaces with a plurality of other devices (e.g., other routers, end user devices). The other interfacing devices appear to each router to be interrupt generators. This is because the arrivals of data packets from the other devices are external events (or triggers) whose occurrence and rate may be unpredictable and non-deterministic. According to an exemplary embodiment of the present invention, each data packet processor in routers 111-114 may execute a plurality of real-time applications over a real-time kernel. A timer typically interrupts these data packet processors (or processing modules) at periodic intervals to make each data packet processor aware of the expiration of time.

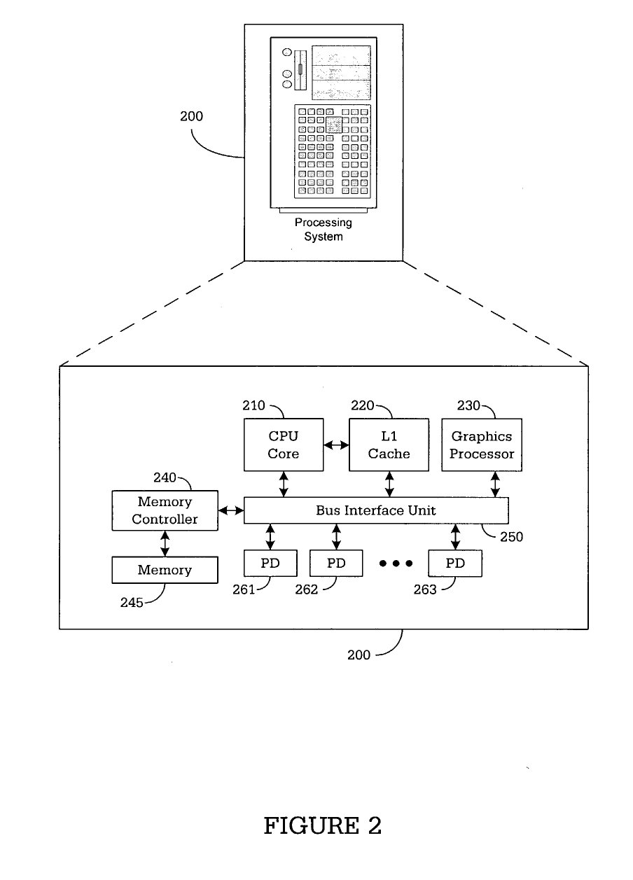

FIG. 2 provides a second example of a real-time processing system (e.g., server, workstation, PC) in which resource sharing based on the leaky bucket algorithm may be implemented in accordance with the principles of the present invention. FIG. 2 illustrates selected portions of exemplary processing system 200 according to an advantageous embodiment of the present invention. Processing system 200 comprises central processing unit (CPU) core 210, Level 1 (L1) cache 220, graphics processor 230, memory controller 240, memory 245, bus interface unit 250, and up to N peripheral devices, including exemplary peripheral device (PD) 261, exemplary peripheral device (PD) 262, and exemplary peripheral device (PD) 263.

CPU core 210 comprises conventional processing architecture devices including for example, a translation look-aside buffer (TLB), a memory management unit (MMU), an integer unit (IU), a floating point unit, a bus controller, and the like. According to an exemplary embodiment of the present invention, L1 cache comprises an instruction cache and a data cache that store instructions and data needed by CPU core 210. When there is a miss to the instruction or data caches or the TLB, memory controller 240 retrieves the missed data or instruction from memory 245.

Graphics processor 230 interfaces between CPU core 10 and a display device (not shown) that may be associated with processing system 200. According to an exemplary embodiment of the present invention, graphics processor 230 comprises a BitBLT/vector engine that supports pattern generation, source expansion, pattern/source transparency, and ternary raster operations.

CPU core 210 communicates with memory controller 240, graphics processor 230, and the N peripheral devices, including PD 261, PD 262, and PD 263, via bus interface unit (BIU) 250. The N peripheral devices may comprise, for example, a Peripheral Component Interconnect (PCI) bridge, an I/O interface card for a pointing device (e.g., mouse), an Ethernet network interface card (NIC), or the like. According to the principles of the present invention, each of the N peripheral devices generates interrupt service requests that are transmitted to CPU core 210 via BIU 250.

CPU core 210 in processing system 200 provides a real-time processing environment that interfaces with a plurality of other devices (e.g., PD 261, PD 262, PD 263, external devices, and the like). The peripheral devices and other external devices appear to CPU core 210 to be interrupt generators. According to an exemplary embodiment of the present invention, CPU core 210 may execute a plurality of real-time applications over a real-time kernel. A timer typically interrupts CPU core 210 at periodic intervals to make CPU core 210 aware of the expiration of time.

Generally speaking, the present invention may be implemented in any real-time environment in which the following basic components exist:

1) A general-purpose processor module with a central processing unit (CPU) and memory that hosts several real-time applications over a real-time kernel;

2) A timing device that interrupts the processor module at periodic intervals (on the order of milliseconds) and runs at a higher priority than other interrupt sources. This type of timer is used in many types of real-time systems to make the system aware of time expiration; and

3) N interrupt-generating sources (i.e., peripherals and system devices) having different interrupt priorities connected to the processor module.

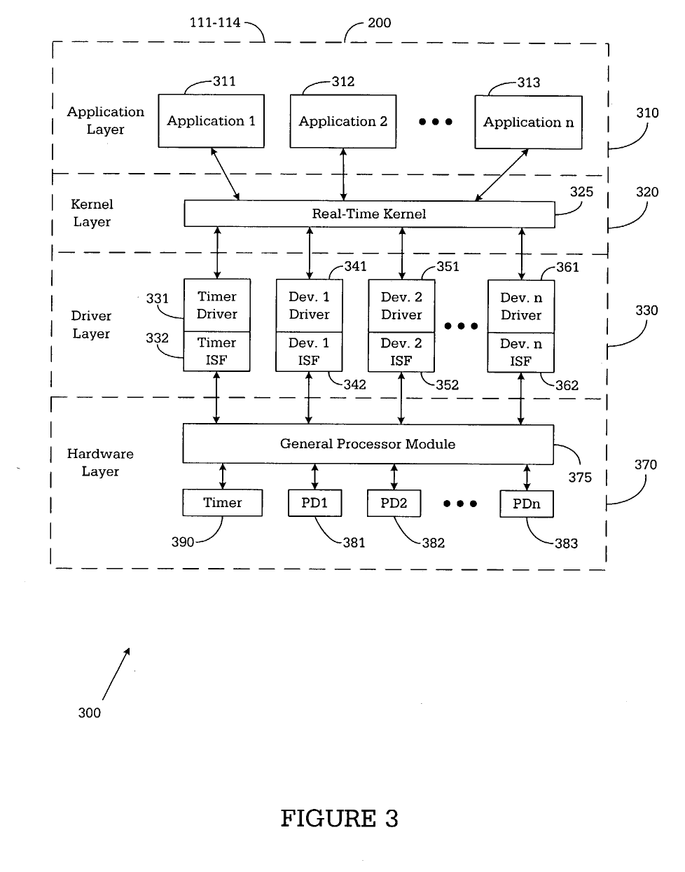

FIG. 3 depicts operational flow diagram 300, which illustrates the operation of real-time processing architecture 300 according to the principles of the present invention. Real-time processing architecture 300 is intended to be a generalized representation of the functional layers of any one of routers 111-114 or processing system 200. Real-time processing architecture 300 comprises application layer 310, kernel layer 320, driver layer 330, and hardware layer 370. Application layer 310 comprises up to N applications, including exemplary applications 311, 312, and 313. Kernel layer 320 comprises real-time kernel 325. Driver layer 330 comprises timer driver 331, timer interrupt service function (ISF) 332, N device drivers, and N device interrupt service functions (ISFs). Hardware layer 370 comprises general processor module 375, N peripheral devices, including exemplary peripheral devices 381, 382 and 383, and timer 390.

Application 311, 312 and 313 are arbitrarily labeled Application 1, Application 2, and Application N. The N device drivers include exemplary device drivers 341, 351, and 361, which are arbitrarily labeled Device 1 Driver, Device 2 Driver, and Device 3 Driver, respectively. The N device interrupt service functions include exemplary device interrupt service function (ISF) 342, device interrupt service function (ISF) 352, and device interrupt service function (ISF) 362, which are arbitrarily labeled Device 1 ISF, Device 2 ISF, and Device 3 ISF, respectively.

Each of applications 311-313 communicates with real-time kernel 325 in kernel layer 325. Real-time kernel 325 communicates in turn with timer driver 331 and the N device drivers in driver layer 330. Timer driver 331 and timer ISF 332 are associated with timer 390. Peripheral device 381 communicates with real-time kernel 325 via device driver 341 and device ISF 342. Peripheral device 382 communicates with real-time kernel 325 via device driver 351 and device ISF 352. Peripheral device 383 communicates with real-time kernel 325 via device driver 361 and device ISF 362.

For simplicity of explanation, it is assumed that real-time processing architecture 300 is router 111, which has N physical interfaces that communicate with processor module 375 in router 111. However, it should be understood that the description that follows also applies to many other real-time systems, including processing system 200. The N peripheral devices in router 111 represent the N interfaces to external devices (i.e., other routers and end-user devices). Router 111 runs several routing and signaling applications 311, 312, 313 on top of real-time kernel 325. The “time tick” is managed using timer 390, which interrupts real-time kernel in processor module 375 at periodic intervals. Device interrupt service functions 342, 352 and 362 are implemented as part of device drivers 341, 351 and 361 and are invoked to move data packets in and out of router 111. The N peripheral devices are able to handle packets at line rate even though the software cannot process these packets at line rate from multiple ports simultaneously in a sustained manner.

Router 111 receives data packet traffic from external sources via the peripheral devices in an uncontrollable and unpredictable manner, sometimes for lengthy durations. This could cause the interrupt service functions to occupy most of the processor resources for considerable duration. This would, in turn, prevent real-time kernel 325, the signaling stacks and the applications from running for considerable periods of time. Ultimately, this could eventually cause external systems communicating with router 111 (e.g., peer end of the signaling agent) to determine that router 111 was not responding. The external devices might then initiate link (or module) failure notifications to other entities in the network.

The present invention prevents this from happening by using a leaky bucket rate control mechanism for each interrupt source or a group of similar interrupt sources. The leaky bucket algorithm allows an interrupt source or group of interrupt sources to have a burst of interrupts at any given time for some duration at a peak rate, even though the average rate of interrupts cannot exceed the sustained rate. According to a first exemplary embodiment of the present invention, router 111 implements a common leaky bucket for each group of similar interrupt sources. According to a second exemplary embodiment of the present invention, router 111 implements a unique leaky bucket for each interrupt source (i.e., group size equal to 1). Implementing a common leaky bucket enables a simpler mechanism to be used, even though there is no control among the members of the group. For simplicity, it is assumed hereafter that a single leaky bucket is implemented for a group of peripheral devices.

Two user-defined parameters are used to throttle the processor resources used by the interrupt service functions (routines). These two parameters, which are configured for each leaky bucket, are: i) Sustained Service Rate (SSR); and ii) Burst Size (BS). The SSR parameter represents the long-term average rate for servicing the members of the group and is expressed in units of “events/second.” The BS parameter is the maximum number of events that can occur at any given time as a burst and is represented as “number of events.”

As in the case of conventional leaky bucket algorithms, the present invention provides a token crediting mechanism that fills the token bucket at a rate of SSR. The bucket size is equal to the BS value. The interrupting sources of each group removes tokens at a rate equivalent to the amount of jobs completed in every invocation. For simplicity of explanation, it is assumed that one (1) token is removed every time an interrupt service function (or routine) is invoked. (In reality, the interrupt service functions are implemented to process multiple events at each execution in order to improve the overall performance and to reduce interrupt latency.) In such an implementation, the token crediting is done from timer interrupt service function 332, which runs as a higher priority process from the interrupt context at periodic intervals.

During initialization, each group registers to the token crediting function (i.e., timer ISF 332) with the following items through a shared data structure: i) SSR of the group; ii) BS of the group; iii) an interrupt enable method which, when invoked, enables interrupt of each member of the group; and iv) a location called Available Credits, which is initially filled with the BS value.

It is assumed that the periodicity of the timer routine is T milliseconds. Periodic timer interrupt service function (ISF) 332 does the following during each of its invocation for every registered group:

1) Increments the Available Credits value by (SSR*T)/1000. If the available credits value is greater than BS, timer ISF 332 sets the Available Credits value equal to BS; and

2) Invokes the interrupt enable method, if any of the interrupts are already disabled.

When one of the N peripheral devices (e.g., PD 381, PD 382, PD 383) receives an external trigger (e.g., receives a data packet), the peripheral device interrupts processor module 375 and corresponding interrupt service functions get invoked. Every member of an interrupt service function group does the following at the end of servicing a current interrupt:

1) decrements the Current Credits value by a unit amount corresponding to the amount of processing done in the current iteration. It is assumed this unit amount is 1 for simplicity; and

2) if the Current Credits value becomes zero or less, disables the interrupt at hardware layer 370. No further interrupt will occur from the peripheral device until the interrupt is re-enabled from the token crediting function.

The leaky bucket-based thresholding mechanism of the present invention effectively limits the amount of resources processor module 375 are consumed by device interrupt service functions (e.g., device ISF 342, device ISF 352, device ISF 353), and gives enough time for real-time kernel 325 and applications 311, 312 and 313, among others, to run even when there is a large burst of interrupt activity.

The leaky bucket algorithm of the present invention does not prevent peripheral devices 381, 382, 383, etc., from creating bursts of interrupt requests for short duration (configurable) The present invention also effectively regulates the long-term processor resource allocation of the system.

Although the present invention has been described with an exemplary embodiment, various changes and modifications may be suggested to one skilled in the art. It is intended that the present invention encompass such changes and modifications as fall within the scope of the appended claims.

What is claimed is:

1. A real-time processing system (i) operable to execute application, kernel and interrupt-service processes utilizing processor resources selectively allocated thereto and (ii) capable of handling interrupt-service requests received from interrupt sources associated with said real-time processing system, said real-time processing system comprising a controller that monitors resource-utilization limits associated with each of said interrupt sources.

2. The real-time process control system of claim 1 wherein at least one of said interrupt-service requests is received from a peripheral device associated with said real-time processing system.

3. The real-time process control system of claim 1 wherein said controller is operable to associate at least one resource-utilization limit with each of said interrupt sources.

4. The real-time process control system of claim 1 wherein said controller is operable, in response to monitoring said resource-utilization limits, to allocate selectively said processor resources among ones of said application, kernel and interrupt-service processes.

5. The real-time process control system of claim 1 wherein said controller is operable to reset said resource-utilization limits.

6. The real-time process control system of claim 5 wherein said controller resets said resource-utilization limits in response to a timer.

7. The real-time process control system of claim 6 wherein said timer resets upon expiration of a time period T.

8. The real-time process control system of claim 1 wherein said controller is operable to modify said resource-utilization limits.

9. The real-time process control system of claim 1 wherein said controller is operable to modify a first resource-utilization limit associated with a first interrupt source as a function of said first interrupt source utilization of said processor resources.

10. The real-time process control system of claim 1 wherein said controller is operable to modify selectively said resource-utilization limits associated with said interrupt sources as a function of said interrupt sources utilization of said processor resources.

11. The real-time process control system of claim 10 wherein said controller is operable, in response to monitoring said modified resource-utilization limits, to allocate selectively said processor resources among ones of said application, kernel and interrupt-service processes.

12. The real-time process control system of claim 1 wherein said processor resources comprise at least one processor and memory.

13. The real-time process control system of claim 1 wherein each of said interrupt sources has a priority value associated therewith, wherein some said interrupt sources have a higher priority value relative to other said interrupt sources.

14. The real-time process control system of claim 13 wherein said controller is operable, in response to said priority values and said resource-utilization limits, to allocate selectively said processor resources among ones of said application, kernel and interrupt-service processes.

15. The real-time processing system of claim 1 wherein each said resource-utilization limit comprises a first parameter representing a maximum number of events that can occur during a given time period T.

16. The real-time processing system of claim 15 wherein each said resource-utilization limit comprises a second parameter representing an average number of events serviced per second.

17. A method of operating a real-time processing system (i) operable to execute application, kernel and interrupt-service processes utilizing processor resources selectively allocated thereto and (ii) capable of handling interrupt-service requests received from interrupt sources associated with said real-time processing system, said method of operation comprising the step of monitoring resource-utilization limits associated with each of said interrupt sources.

18. The method of operation set forth in claim 17 further comprising the step of receiving at least one of said interrupt-service requests from a peripheral device associated with said real-time processing system.

19. The method of operation set forth in claim 17 further comprising the step of associating at least one resource-utilization limit with each of said interrupt sources.

20. The method of operation set forth in claim 17 further comprising the step of allocating selectively said processor resources among ones of said application, kernel and interrupt-service processes in response to monitoring said resource-utilization limits.

21. The method of operation set forth in claim 17 further comprising the step of resetting said resource-utilization limits.

22. The method of operation set forth in claim 21 further comprising the step of resetting said resource-utilization limits in response to a timer.

23. The method of operation set forth in claim 22 further comprising the step of resetting said resource-utilization limits upon expiration of a time period T.

24. The method of operation set forth in claim 17 further comprising the step of modifying said resource-utilization limits.

25. The method of operation set forth in claim 22 further comprising the step of modifying a first resource-utilization limit associated with a first interrupt source as a function of said first interrupt source utilization of said processor resources.

26. The method of operation set forth in claim 22 further comprising the step of modifying selectively said resource-utilization limits associated with said interrupt sources as a function of said interrupt sources utilization of said processor resources.

27. The method of operation set forth in claim 26 further comprising the step of allocate selectively, in response to monitoring said modified resource-utilization limits, said processor resources among ones of said application, kernel and interrupt-service processes.

28. The method of operation set forth in claim 17 wherein said processor resources comprise at least one processor and memory.

29. The method of operation set forth in claim 17 wherein each of said interrupt sources has a priority value associated therewith, and wherein some said interrupt sources have a higher priority value relative to other said interrupt sources.

30. The method of operation set forth in claim 29 further comprising the step of allocating selectively, in response to said priority values and said resource-utilization limits, said processor resources among ones of said application, kernel and interrupt-service processes.

31. The method of operation set forth in claim 17 wherein each said resource-utilization limit comprises a first parameter representing a maximum number of events that can occur during a given time period T.

32. The method of operation set forth in claim 31 wherein each said resource-utilization limit comprises a second parameter representing an average number of events serviced per second.
